(19) United States
(12) Patent Application Publication
(10) Pub. No.: US 2012/0108717 A1
(43) Pub. Date: May 3, 2012

(54) INK COMPOSITION FOR FLEXO PRINTING

(75) Inventors: Eun Ah Park, Yongin-si (KR); Jong Woo Lee, Suwon-si (KR); Eun Soo Hwang, Seoul (KR); Young Tae Cho, Suwon-si (KR); Jeong Gil Kim, Suwon-si (KR)

(73) Assignee: SAMSUNG ELECTRONICS CO., LTD., Suwon-si (KR)

(21) Appl. No.: 13/187,967

(22) Filed: Jul. 21, 2011

(30) Foreign Application Priority Data
Oct. 27, 2010 (KR) 10-2010-0105237

(51) Int. Cl. C09D 11/10

(52) U.S. Cl. 524/157; 524/190

(57) ABSTRACT

An ink composition for flexo printing contains a dye type colorant in order to precisely print. The ink composition for flexo printing includes about 1 to 40 wt. % of a colorant, about 5 to 40 wt. % of a binder, about 20 to 95 wt. % of a solvent and a remainder of an additive, wherein the wt. % of the colorant, the binder, the solvent and the additive is based on a total weight of the ink composition.

### CROSS-REFERENCE TO RELATED APPLICATION

This application claims the benefit of Korean Patent Application No. 2010-105237, filed on Oct. 27, 2010 with the Korean Intellectual Property Office, the entire contents of which are incorporated herein by reference.

### BACKGROUND

1. Field

Example embodiments relate to an ink composition for flexo printing applicable to micropattern printing.

2. Description of the Related Art

Flexo (or flexographic) printing is a printing method using a print frame made of a resin or rubber block panel as well as a dry solvent type ink. In general, flexo printing may be performed by applying ink to a substrate to a predetermined or given thickness using a blade, releasing the thinly coated ink from the substrate using a print frame, on which positive patterns to be printed are formed, and transferring the ink to a predetermined or given printing side, thereby printing the patterns.

In order to print micropatterns having a size of less than several tens micrometers according to a flexo printing method, a colorant contained in ink should be dissolved in a solvent or must be present in the form of nano-sized particles. However, a pigment generally used as the ink colorant has a particle size of more than several micrometers, and therefore, is not suitable for micropattern printing.

Also, in the flexo printing method, because control of ink coating thickness and/or drying conditions during printing are difficult, there are problems in precisely printing micropatterns. Such precise printing of micropatterns on a printing side requires desirable dryness of the ink and wettability thereof to a print frame or the printing side.

### SUMMARY

According to example embodiments, an ink composition may include a dye type colorant in order to precisely print micropatterns. An ink composition for flexo printing according to example embodiments may include about 1 to 40 wt. % of a colorant, about 5 to 40 wt. % of a binder, about 20 to 95 wt. % of a solvent and a remainder of an additive, wherein the wt. % of the colorant, the binder, the solvent and the additive is based on a total weight of the ink composition.

The colorant may be a dye for printing micropatterns, and the dye may be at least one selected from a group consisting of C.I. solvent black 3, 7, 27, 43, 46, 47; C.I. solvent blue 2, 4, 5, 37, 38, 43, 44, 51, 64, 14; C.I. basic blue 1, 7, 45; C.I. solvent red 18, 33, 39, 49, 119, 122, 160; C.I. basic red 1, 14; C.I. acid yellow 23, 36, 42; and C.I. solvent orange 37. The micropatterns may have a size of less than about 100 μm.

The binder may be at least one selected from a group consisting of polyvinyl pyrrolidone, polyvinyl butyral, polyacrylate, phenol resin, ketone resin, pine resin, maleic resin, dammar gum, balsam resin, alkyd resin and siloxane resin, trocellulose, polyamide resin, vinyl chloride, vinyl acetate copolymer resin, chloride rubber, chlorinated propylene, acryl resin, polyurethane resin, melamine resin and epoxy resin. The binder may further include less than about 20 wt % of a surfactant based on a total weight of the ink composition.

The surfactant may contain at least one selected from a group consisting of a fluorine compound, a silane compound, an ester compound, an ether compound, a nitrogen-containing compound, carboxylate, sulfonate, an amine salt and an ammonium salt.

The solvent may be at least one selected from a group consisting of alcohol, glycol, ether and acetate. The solvent may have 10 or fewer carbon atoms. The solvent may have a vapor pressure of less than about 2 mmHg at 20° C. and may be about 2 to 15 wt. % based on a total weight of the ink composition. The alcohol may be about 50 to 60 wt. % based on a total weight of the ink composition.

According to example embodiments, the use of a dye type colorant may enable easier formation of micropatterns. In addition, an ink composition having wettability and dryness suitable for micropattern printing may be produced.

### DETAILED DESCRIPTION

Hereinafter, advantageous features and characteristics of example embodiments and practical methods thereof will be clearly understood through the following detailed description of illustrative embodiments. However, at least one example embodiment may be embodied in various other forms, which are not particularly restricted to those described herein.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be described in detail by way of the following examples.

### Example 1

A dye, a solvent and a binder were blended and agitated. The dye was C.I. solvent red 18, the solvent was a mixture of ethanol, 2-ethyl hexanol and ethyleneglycol ether, and the binder was a mixture of polyvinyl butyral, ketone resin and siloxane resin.

About 10 wt. % of C.I. solvent red 18, about 52.5 wt. % of ethanol, about 7 wt. % of 2-ethyl hexanol, about 15 wt. % of ethyleneglycol ether, about 3 wt. % of polyvinyl butyral, about 5 wt. % of ketone resin and about 7.5 wt. % of siloxane were mixed under agitation, thereby resulting in an ink composition for flexo printing.

### Example 2

A dye, a solvent and a binder were blended and agitated. The dye was C.I. solvent red 18, the solvent was a mixture of ethanol, 2-ethyl hexanol, ethyleneglycol ether and ethyleneglycol, and the binder was a mixture of polyvinyl butyral, ketone resin and siloxane resin.

About 10 wt. % of C.I. solvent red 18, about 50 wt. % of ethanol, about 7 wt. % of 2-ethyl hexanol, about 15 wt. % of ethyleneglycol ether, about 5 wt. % of ethyleneglycol, about 3 wt. % of polyvinyl butyral, about 5 wt. % of ketone resin and about 5 wt. % of siloxane were mixed under agitation, thereby resulting in an ink composition for flexo printing.

### Comparative Example 1

A dye, a solvent and a binder were blended and agitated. The dye was C.I. solvent red 18, the solvent was a mixture of ethanol, 2-ethyl hexanol and ethyleneglycol ether, and the binder was a mixture of polyvinyl butyral and ketone resin.

About 10 wt. % of C.I. solvent red 18, about 60 wt. % of ethanol, about 7 wt. % of 2-ethyl hexanol, about 15 wt. % of ethyleneglycol ether, about 3 wt. % of polyvinyl butyral and about 5 wt. % of ketone resin were mixed under agitation, thereby resulting in an ink composition for flexo printing.

### Comparative Example 2

A dye, a solvent and a binder were blended and agitated. The dye was C.I. solvent red 18, the solvent was a mixture of ethanol, 2-ethyl hexanol, ethyleneglycol ether and ethyleneglycol, and the binder was a mixture of polyvinyl butyral, ketone resin and siloxane resin.

About 10 wt. % of C.I. solvent red 18, about 35 wt. % of ethanol, about 7 wt. % of 2-ethyl hexanol, about 15 wt. % of ethyleneglycol ether, about 20 wt. % of ethyleneglycol, about 3 wt. % of polyvinyl butyral, about 5 wt. % of ketone resin and about 5 wt. % of siloxane resin were mixed under agitation, thereby resulting in an ink composition for flexo printing.

### Comparative Example 3

A dye, a solvent and a binder were blended and agitated. The dye was C.I. solvent red 18, the solvent was a mixture of ethanol, 2-ethyl hexanol and ethyleneglycol ether, and the binder was a mixture of polyvinyl butyral, ketone resin and siloxane resin.

About 10 wt. % of C.I. solvent red 18, about 70 wt. % of ethanol, about 3 wt. % of 2-ethyl hexanol, about 7 wt. % of ethyleneglycol ether, about 2.5 wt. % of polyvinyl butyral, about 2.5 wt. % of ketone resin and about 5 wt. % of siloxane resin were mixed under agitation, thereby resulting in an ink composition for flexo printing.

### Comparative Example 4

A dye, a solvent and a binder were blended and agitated. The dye was C.I. solvent red 18, the solvent was a mixture of ethanol, propyleneglycol methylether acetate (PGMEA), 2-ethyl hexanol and ethyleneglycol ether, and the binder was a mixture of polyvinyl butyral, ketone resin and siloxane resin.

About 10 wt. % of C.I. solvent red 18, about 50 wt. % of ethanol, about 5 wt. % of PGMEA, about 7 wt. % of 2-ethyl hexanol, about 15 wt. % of ethyleneglycol ether, about 3 wt. % of polyvinyl butyral, about 5 wt. % of ketone resin and about 5 wt. % of siloxane resin were mixed under agitation, thereby resulting in an ink composition for flexo printing.

### Comparative Example 5

A pigment, a solvent and a binder were blended and agitated. The pigment was Pigment red 4, the solvent was a mixture of ethanol, 2-ethyl hexanol and propyleneglycol ether, and the binder was a mixture of polyvinyl butyral, ketone resin and siloxane resin.

About 10 wt. % of Pigment red 4, about 52.5 wt. % of ethanol, about 7 wt. % of 2-ethyl hexanol, about 15 wt. % of ethyleneglycol ether, about 3 wt. % of polyvinyl butyral, about 5 wt. % of ketone resin and about 7.5 wt. % of siloxane resin were mixed under agitation, thereby resulting in an ink composition for flexo printing.

### Experimental Example 1

Ink compositions were prepared according to Example 1 and Comparative Example 5, respectively. Using both these ink compositions, patterns with a size of 10 μm were printed. A print frame made of polydimethyl siloxane (PDMS) was used to print the patterns on substrates (hereinafter referred to as ‘printing side’) made of polyimide, silicon oxide, glass and carbonate materials, respectively. Pattern printing precision for each material is shown in Table 1.

TABLE 1

| | | | Comparative |
|---|---|---|---|
| | | Example 1 | Example 5 |
| Pattern printing | Polyimide | ◯ | Δ |
| precision on printing | Silicon oxide | ⊚ | Δ |
| side | Glass | ⊚ | Δ |
| | Polycarbonate | ◯ | Δ |

() Definition of pattern printing precision
⊚ (more than 90% pattern precision): less than 10% of pattern area is not filled with pattern image or pattern spreading is present therein.
◯ (more than 50% pattern precision): less than 50% of pattern area is not filled with pattern image or pattern spreading is present therein.
Δ (more than 30% pattern precision): less than 70% of pattern area is not filled with pattern image or pattern spreading is present therein.
X (less than 30% pattern precision): less than 90% of pattern area is not filled with pattern image or pattern spreading is present therein.

The foregoing pattern printing precision may be more than about 50%. As shown in TABLE 1, Comparative Example 5 describes use of a pigment as a colorant instead of dye in order to synthesize an ink composition and shows a considerable difference in pattern printing precision, as compared to the ink composition prepared in Example 1.

Although C.I. solvent red 18 was used as a dye in Example 1, at least one selected from a group consisting of: C.I. solvent black 3, 7, 27, 43, 46, 47; C.I. solvent blue 2, 4, 5, 37, 38, 43, 44, 51, 64, 14; C.I. basic blue 1, 7, 45; C.I. solvent red 33, 39, 49, 119, 122, 160; C.I. basic red 1, 14; C.I. acid yellow 23, 36, 42; and C.I. solvent orange 37, as well as mixtures thereof may also be used.

In order to print micropatterns having a size less than about 10 μm, a colorant must be dissolved in an ink composition, or nanoscale colorant particles must be employed. For instance, because a pigment type colorant has a micrometer scale particle size, the pigment type colorant is undesirable for printing micropatterns having a size of less than about 10 μm. On the other hand, dyes are generally dissolved in a solvent, thus being mainly employed in the printing of micropatterns.

When using a dye as the colorant in Example 1, each of the printing sides made of various materials showed more than about 50% pattern precision. On the other hand, the pattern precision in Comparative Example 1 was more than about 30%, thus being insufficient for micropattern printing.

### Experimental Example 2

Ink compositions were prepared according to Example 1 and Comparative Examples 2, 3 and 4, respectively. After applying each of these ink compositions to a substrate to a thickness of less than about 10 μm, the coated substrate was left at room temperature to dry, followed by measurement of a drying time. Time required for drying each of the ink compositions is shown in Table 2.

TABLE 2

| | | Comparative | Comparative | Comparative |
|---|---|---|---|---|
| | Example 2 | Example 2 | Example 3 | Example 4 |
| Dry time | Within 120 | Not dried after | Within 10 | Within 30 |
| | seconds | 4 minutes | seconds | seconds |

() If less than 70% of the pattern area was not filled with the pattern image when the coating ink was transferred to a print frame, the ink composition was determined to be dry.

The ink composition dry time may range from about 90 to 120 seconds, in consideration of time required for a printing process. As for micropattern printing, drying characteristics of an ink composition are an important factor.

When a dry time of an ink (or ink composition) is shorter than a printing time, the ink may dry before transfer of the same to a print frame or before printing patterns on a printing side. As a result, precision printing of micropatterns may be unsuccessful. Meanwhile, if the dry time of the ink is much longer than the printing time, the ink may not be evenly transferred to the print frame and/or pattern spreading over the printing side may occur during pattern printing. Such drying characteristics of the ink closely depend upon types of solvents and/or contents thereof, which are added to an ink composition for preparation of the ink.

In order to control a dry time of the ink composition, a solvent having a low vapor pressure may be added to the composition to decrease a drying rate of the ink composition. Otherwise, another solvent having a high vapor pressure may be added to the composition to increase a drying rate of the same. However, if excess solvent having a low vapor pressure is added, the drying rate may be too low for the ink composition to completely dry during printing, thus reducing printing effects.

In order to maintain the dry time of the ink composition in a range of 90 to 120 seconds, the ink composition according to example embodiments may include a solvent having a vapor pressure of about 2 mmHg at about 20° C. A content of the ink composition may range from about 2 to 15 wt. % relative to 100 wt. % of the ink composition.

Comparing Example 2 with Comparative Example 4, the ink composition in Example 2 has about 5 wt. % of ethyleneglycol while the ink composition in Comparative Example 4 contains about 5 wt. % of PGMEA. As a result, the ink composition in Example 2 dried within about 120 seconds while the ink composition in Comparative Example 4 dried within about 30 seconds.

More particularly, ethyleneglycol has a vapor pressure of about 0.05 mmHg at about 20° C., which is considerably lower than the vapor pressure of the solvent used in the ink composition, about 2 mmHg. On the other hand, a vapor pressure of PGMEA is about 2.5 mmHg at about 20° C. higher than the vapor pressure of the foregoing solvent, that is, about 2 mmHg. Although the ink composition in Comparative Example 4 contains the same amount of PGMEA as ethyleneglycol in the ink composition in Example 2, Comparative Example 4 using PGMEA with the vapor pressure of about 2.5 mmHg exhibits drying characteristics that are not suitable for micropattern printing because the ink composition dried in a relatively short time, that is, within about 30 seconds, compared to the ink composition in Example 2 wherein ethyleneglycol having the vapor pressure of about 0.05 mmHg is used to attain a predetermined or given drying time.

Comparing Example 2 with Comparative Example 2, the ink composition in Example 2 contains about 5 wt. % of ethyleneglycol while the ink composition in Comparative Example 2 contains about 20 wt. % of ethyleneglycol. As a result, the ink composition in Example 2 dried within about 120 seconds while the ink composition in Comparative Example 4 did not completely dry even after about 4 minutes.

As described above, ethyleneglycol has a vapor pressure of about 0.05 mmHg at about 20° C., which is lower than the about 2 mmHg vapor pressure of the solvent used in the ink composition. Accordingly, ethyleneglycol may be added to a solvent to delay drying of the ink composition according to example embodiments.

The ink composition in Example 2 has a content of ethyleneglycol of less than about 15 wt. % while the ink composition in Comparative Example 2 contains about 20 wt. % of ethyleneglycol, which is higher than the content thereof in the ink composition according to Example 2. As a result, the ink composition in Comparative Example 2 containing more than about 15 wt. % of ethyleneglycol exhibits drying characteristics that are not suitable for micropattern printing because the ink composition did not dry even after about 4 minutes, as compared to the ink composition in Example 2 that includes less than about 15 wt. % of ethyleneglycol so as to attain a predetermined or given drying time.

In order to maintain the drying time of the ink composition in a range of about 90 to 120 seconds, the ink composition according to example embodiments may include about 50 to 60 wt. % of an alcohol solvent relative to 100 wt. % of the ink composition. Alcohol, for example, ethanol, is a volatile material having a vapor pressure of about 40 mmHg at about 20° C. and 1 atm, and as an alcohol content of a substance increases, the substance more rapidly dries. Therefore, alcohol may be used to control (or improve) a drying rate of the ink composition according to example embodiments.

Comparing Example 2 with Comparative Example 3, the ink composition in Example 2 includes about 57 wt. % of an alcohol solvent comprising about 50 wt. % ethanol and about 7 wt. % 2-ethyl hexanol while the ink composition in Comparative Example 3 includes about 73 wt. % of an alcohol solvent comprising about 70 wt. % ethanol and about 3 wt. % 2-ethyl hexanol.

As a result, the ink composition in Example 2 dried within about 120 seconds while the ink composition in Comparative Example 3 dried within about 10 seconds. Therefore, the ink composition in Comparative Example 3 including the alcohol solvent in an amount of more than about 60 wt. % exhibits drying characteristics that are not suitable for micropattern printing because the ink composition rapidly dried within as little as about 10 seconds, as compared to the ink composition in Example 2 that includes about 50 to 60 wt. % of the alcohol solvent so as to attain a predetermined or given drying time.

### Experimental Example 3

Ink compositions were prepared according to Example 1 and Comparative Example 1, respectively. Using both these ink compositions, patterns with a size of about 10 μm were printed. A print frame made of PDMS was used to print the patterns on printing sides made of polyimide, silicon oxide, glass and carbonate materials, respectively. Pattern printing precision for each material is shown in Table 3.

TABLE 3

| | | | Comparative |
|---|---|---|---|
| | | Example 1 | Example 1 |
| Pattern printing precision on print frame | | ⊚ | Δ |
| Pattern printing | Polyimide | ◯ | X |
| precision on printing | Silicon oxide | ⊚ | Δ |
| side | Glass | ⊚ | Δ |
| | Polycarbonate | ◯ | X |

() Definition of pattern printing precision
⊚ (more than 90% pattern precision): less than 10% of pattern area is not filled with pattern image or pattern spreading is present therein
◯ (more than 50% pattern precision): less than 50% of pattern area is not filled with pattern image or pattern spreading is present therein.
Δ (more than 30% pattern precision): less than 70% of pattern area is not filled with pattern image or pattern spreading is present therein.
X (less than 30% pattern precision): less than 90% of pattern area is not filled with pattern image or pattern spreading is present therein.

The foregoing pattern printing precision may be more than about 50%. In order to improve the pattern printing precision in printing micropatterns, favorable wettability of an ink to a print frame is required. Since the PDMS print frame is hydrophobic, surface energy (or surface tension) of the ink may be decreased to improve wettability of the same to the print frame.

The ink composition according to example embodiments may contain a binder and a surfactant added to the binder, thus enhancing wettability thereof to a hydrophobic surface of the print frame.

The binder may be at least one selected from a group consisting of polyvinyl pyrrolidone, polyvinyl butyral, polyacrylate, phenol resin, ketone resin, pine resin, maleic resin, dammar gum, balsam resin, alkyd resin and siloxane resin, trocellulose, polyamide resin, vinyl chloride, vinyl acetate copolymer resin, chloride rubber, chlorinated propylene, acryl resin, polyurethane resin, melamine resin, epoxy resin, and mixtures thereof.

The surfactant may be a surfactant containing a fluorine compound, a silane compound, an ester compound, an ether compound, a nitrogen-containing compound, carboxylate, sulfonate, an amine salt and/or an ammonium salt.

In order to attain more than about 50% pattern precision to different print frames and/or printing substrates made of various materials, the binder used in the ink composition according to example embodiments may contain the surfactant in an amount of less than about 20 wt. % relative to 100 wt. % of the ink composition.

Comparing Example 1 with Comparative Example 1, the ink composition in Example 1 includes about 7.5 wt. % of siloxane resin as the surfactant, and the ink composition in Comparative Example 1 does not contain the siloxane resin.

As a result, the ink composition in Example 1 showed a higher pattern precision of more than about 90% to a print frame, whereas the ink composition in Comparative Example 1 showed a relatively lower pattern precision of more than about 30% to a print frame.

Furthermore, the ink composition in Example 1 exhibits a more desirable pattern printing precision of more than about 50% or 90% to four different printing sides, whereas the ink composition in Comparative Example 1 has a relatively low pattern printing precision of about 30% or less to the foregoing printing sides.

Consequently, compared to Example 1 describing an ink composition which includes about 7.5 wt. % of siloxane resin as the surfactant so as to attain improved pattern printing precision to a print frame and a substrate to be printed, the ink composition in Comparative Example 1 without siloxane resin shows pattern printing precision undesirable for micropattern printing.

Although example embodiments have been shown and described above, it is clearly understood that the foregoing embodiments do not particularly restrict the scope of example embodiments. Accordingly, it would be appreciated by those skilled in the art that various substitutions, variations and/or modifications may be made in example embodiments without departing from the principles and spirit of the following claims.

What is claimed is:

1. An ink composition for flexo printing, comprising:
about 1 to 40 wt. % of a colorant;
about 5 to 40 wt. % of a binder;
about 20 to 95 wt. % of a solvent; and
a remainder of an additive,
wherein the wt. % of the colorant, the binder, the solvent and the additive is based on a total weight of the ink composition.

2. The ink composition for flexo printing according to claim 1, wherein the colorant is a dye for printing micropatterns, and the dye is at least one selected from a group consisting of C.I. solvent black 3, 7, 27, 43, 46, 47; C.I. solvent blue 2, 4, 5, 37, 38, 43, 44, 51, 64, 14; C.I. basic blue 1, 7, 45; C.I. solvent red 18, 33, 39, 49, 119, 122, 160; C.I. basic red 1, 14; C.I. acid yellow 23, 36, 42; and C.I. solvent orange 37.

3. The ink composition for flexo printing according to claim 2, wherein the micropatterns have a size of less than about 100 μm.

4. The ink composition for flexo printing according to claim 1, wherein the binder is at least one selected from a group consisting of polyvinyl pyrrolidone, polyvinyl butyral, polyacrylate, phenol resin, ketone resin, pine resin, maleic resin, dammar gum, balsam resin, alkyd resin and siloxane resin, trocellulose, polyamide resin, vinyl chloride, vinyl acetate copolymer resin, chloride rubber, chlorinated propylene, acryl resin, polyurethane resin, melamine resin and epoxy resin.

5. The ink composition for flexo printing according to claim 1, wherein the binder further includes less than about 20 wt % of a surfactant based on a total weight of the ink composition.

6. The ink composition for flexo printing according to claim 5, wherein the surfactant contains at least one selected from a group consisting of a fluorine compound, a silane compound, an ester compound, an ether compound, a nitrogen-containing compound, carboxylate, sulfonate, an amine salt and an ammonium salt.

7. The ink composition for flexo printing according to claim 1, wherein the solvent is at least one selected from a group consisting of alcohol, glycol, ether and acetate.

8. The ink composition for flexo printing according to claim 7, wherein the solvent has 10 or fewer carbon atoms.

9. The ink composition for flexo printing according to claim 7, wherein the solvent has a vapor pressure of less than about 2 mmHg at 20° C. and is about 2 to 15 wt. % based on a total weight of the ink composition.

10. The ink composition for flexo printing according to claim 7, wherein the alcohol is about 50 to 60 wt. % based on a total weight of the ink composition.
